(19) United States
(12) Patent Application Publication
(10) Pub. No.: US 2009/0032601 A1
(43) Pub. Date: Feb. 5, 2009

(54) INFORMATION ADVISOR CARD

(76) Inventor: Anthony S. Leanza, Omsted Township, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/182,441

(22) Filed: Jul. 30, 2008

Related U.S. Application Data
(60) Provisional application No. 60/962,950, filed on Aug. 1, 2007.

(51) Int. Cl. G06K 19/00

(52) U.S. Cl. 235/487

(57) ABSTRACT

An information card including a memory device for storing validity information of driver's licenses from more than one jurisdiction means for selectively accessing validity information for a selected jurisdiction, and means for displaying the accessed information.

### CROSS-REFERENCE TO RELATED APPLICATION

This application is based on Provisional Patent Application Ser. No. 60/962,950 filed Aug. 1, 2007, entitled “LICENSE INFORMATION ADVISOR CARD” filed by Leanza, which is hereby fully incorporated herein by reference, and all benefits and rights of which and to which are hereby claimed.

### TECHNICAL FIELD

The present invention relates to an information advisor card and, more particularly, to a license information advisor card that can be carried by a user wishing to establish a third party's identification such as a police officer or a security person.

### BACKGROUND OF THE INVENTION

As part of a police officer's normal duties, he must often check a person's driver's license. This is also true of many other securities personal such as those checking driver's licenses at airports and bars. On a percentage basis, most licenses encounter by the person doing the ID checking on a daily basis are from the home state of the person doing the checking and he/she is familiar with the information that is to be contained on those licenses. It may then be easy for a security person or police officer to spot a fraudulent license alleged to be from his state. However, when a security person or police officer is presented with a driver's license from another state, he/she may not remember what information is to be on that state's license and may not remember the particular layout or arrangement of the information on the out-of-state license. It therefore becomes more difficult to recognize a fraudulent out-of-state license. It is also not uncommon for a state to change its license layout from year-to-year to make counterfeiting more difficult. Such changes make a security or police officer's job even more difficult to keep track of the information for detection of fraudulent licenses.

### SUMMARY OF THE INVENTION

In accordance with an example embodiment of the present invention, an information card is provided including a memory device for storing validity information of driver's licenses from more than one jurisdiction, means for selectively accessing validity information for a selected jurisdiction, and means for displaying the accessed information.

In accordance with another example embodiment of the present invention, an information card usable to verify information on a plurality of identification cards from associated different jurisdictions is provided comprising memory device for storing validity information for the identification cards for each of the possible jurisdictions, means for selectively accessing validity information for a selected jurisdiction, and display for displaying the selected accessed validity information for the selected jurisdiction.

In accordance with yet another example embodiment of the present invention, a method for verifying information on a plurality of identification cards from associated different jurisdictions is provided, said method comprising the steps of storing validity information for each of the possible jurisdictions, selectively accessing the stored validity information, and displaying the selected accessed validity information for the selected jurisdiction.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a top view of an information card made in accordance with one example embodiment of the present invention for slide mounting into a clipboard having a receiving slot;

FIG. 2 is a side view of the clipboard shown in FIG. 1 showing the information card mounted in the receiving slot; and

FIG. 3 is perspective view of the information card in accordance with one example embodiment of the present invention showing a USB port and memory card-receiving slot.

### DETAILED DESCRIPTION

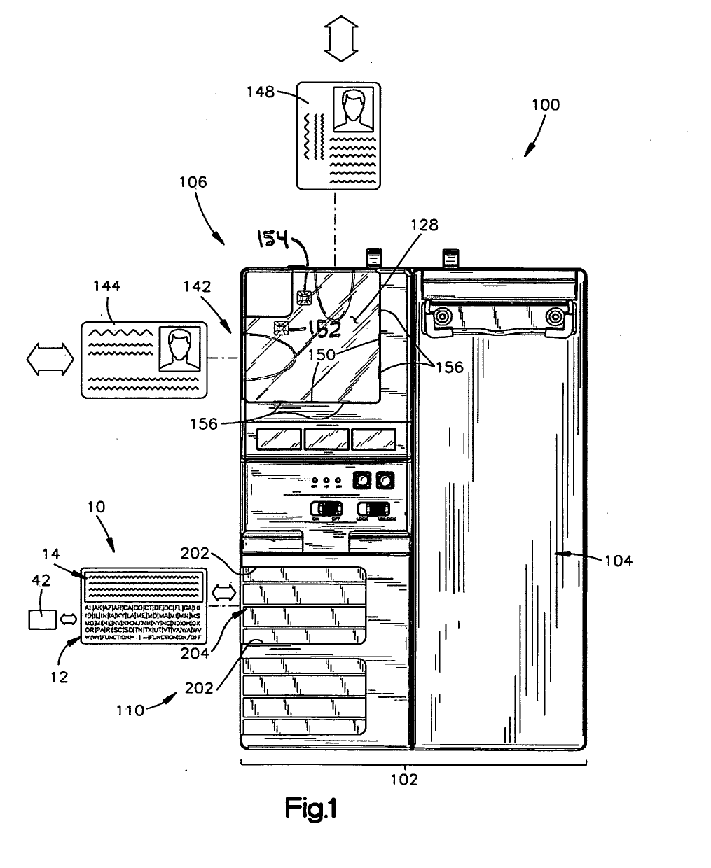

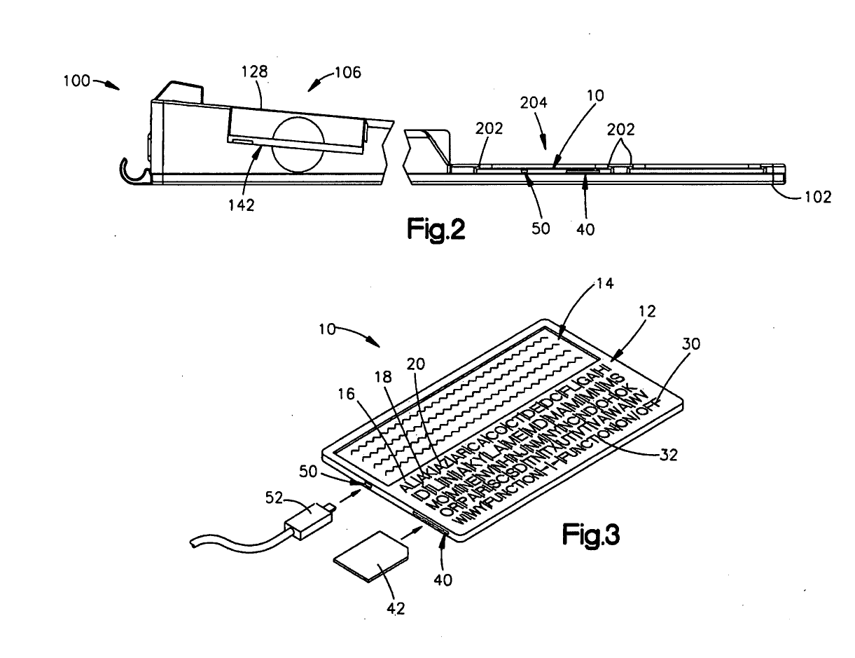

Referring to FIGS. 1-3, an information card 10, in accordance with one example embodiment of the present invention, includes a touch-pad area 12 and a display 14. The touch-pad area 12 includes pressable one area 16, 18, 20, etc. for each of the states of the United States. Other pressable areas that provide information card control functions, such as an ON/OFF function 30, function key right area 32, function key left area 34, etc., may also be provided.

The information card 10 is self-powered with an on-board battery source (not shown) that can be a replaceable battery (button-cell) or a rechargeable battery. The information card 10 further may include a memory card slot 40 for receiving a digital memory card 42 that includes digitally stored information that can be periodically updated. The information card 10 may further include a USB port 50 for connection to an external computer (not shown) via a USB cable 52 for updating information on an internal read/write memory in the information card 10.

The information card 10 may be used as a hand-held device and carried by a police officer or security person in his pocked or may be used in combination with an illuminated clipboard 100 such as fully described in U.S. patent application Ser. No. 11/300,875 entitled “Illuminated Clipboard and Method of Use” and filed Dec. 15, 2005 by Anthony S. Leanza, which is hereby fully incorporated herein by reference and also published as U.S. Patent Application Pub. No. US 2006/0139909 A1 on Jun. 29, 2006. The illuminated clipboard 100 includes a clipboard base 102 having an illuminated ticket-writing area 104, an illuminated license receiving/viewing device 106, a date, clock, and court date information area 108, and an illuminated supplemental license receiving/holding area 110. The illuminated license receiving/viewing device 106 of the illuminated clipboard 100 is located at one corner, e.g., upper left corner, of the clipboard base 102. When a driver's license 144 or 148 (e.g., an out-of-state driver's license) is slid into the illuminated license receiving/viewing device 106, the information on the license can be viewed through the lens 128. Two different illumination sources are provided to illuminate the license receiving/viewing device of the illuminated clipboard 100 so as to aid in reading information on a driver's license 144 or 148 positioned by a clipboard user into one of the slots 142,146 of the illuminated license receiving/viewing device 106. A first license illumination source 150 includes ultraviolet light sources. Driver's licenses 144 or 148 of certain states have information contained on them that can only be seen when placed under ultraviolet light. This information, not otherwise visible using light in the visible spectrum, is used as part of the authentication of the license. A second light source 156, such as incandescent light bulbs, white light sources, or light emitting diodes (“LEDs”), illuminate a driver's license 144 or 148 in the illuminated license receiving/viewing device 106 to aid in viewing written information on the driver's license. The clipboard is arranged so that when one of the driver's licenses 144 or 148 is first inserted and either switch 152, 154 is activated, only the ultraviolet light sources 150 are first turned ON for a predetermined time period, e.g., 2 seconds, and then they are shutoff. When the ultraviolet light sources 150 are shut-off, the other visible light sources 156 are then turned ON and remain ON until the driver's license 144 or 148 is removed. This gives the clipboard operator time to view any hidden ultraviolet invisible information on the driver's license 144 or 148 prior to viewing the written information.

The information card 10 can for convenience be mounted to the illuminated clipboard 100 by sliding the information card 10 into the receiving channels 202 of slot 204.

The information stored in the information card 10 can be stored on a read/write memory of card 10 that is programmable via the USB port 50 connected to a computer or on a digital memory card 42 inserted in the memory card slot 40. The stored information includes all the information needed for a police officer or security person to verify and validate a driver's license of all the states in the United States (any possibly other territories and countries as may be desired).

For example, assume an Ohio police officer was to make a stop of a driver having a driver's license from the state of New York. The Ohio police officer may not be familiar with the information that should be contained on a valid New York driver's license. He would turn ON the information card 10 by pressing the ON/OFF area 30 of the information card 10 and then press the area marked NY on the touch-pad area 12 (The information given below is just an example and may or may not bear any fact as to the information required or contained on an actual driver's license in the state of New York). The display 14 would first include:
1. Flexible laminate
2. ID bar codes
3. CDL Brown (CDL means commercial drivers license)
   The officer would then hit the function key right area 32 on the touch-pad area 12 to advance to the screen that would display the next set of information regarding a NY driver's license for minors including:
1. Red ID number
2. Date of birth
3. UNDER 21 RIGHT SIDE PHOTO
4. LIMITED RIGHT
5. A2 restriction code
   The officer would then hit the function key right area 32 on the touch-pad area 12 to advance the screen which would display the next set of information regarding a NY driver's license including:
1. Wavy line across front
2. Coat of arms in center visible under UV
3. Small coat of arms on top of photo
4. Micro-printing of NY in rows across back visible under UV
5. Prior license
6. State seal hidden in surface
   The officer would then hit the function key right area 32 on the touch-pad area 12 to advance the screen which would display the next set of information regarding a NY driver's license including:
1. 9-digit sequenced in three groups of three, un-hyphenated
   The officer would then hit the function key right area 32 on the touch-pad area 12 to advance the display to the next set of information regarding a NY driver's license including:
1. Valid for 8 years
2. Expire on birthday

If the officer needed to return to a previous screen, he hits the function key left area 34.

Each state has associated stored license information. As mentioned, the license information may change from year-to-year. The information card 10 is updated as needed via the programming connection using the USB port to update an internal read/write memory of card 10 or by replacing the digital memory card 42. It may be also possible to update the digital memory card 42 via the USB port.

As mentioned, the information card 10 can be used alone or in combination with an illuminated clipboard 100.

From the above description of the invention, those skilled in the art will perceive improvements, changes and modifications in the invention. For example, the information card has been described as being used to verify information with regard to use to verify a person's identification based on a driver's license. It may also or alternatively be used to verify identification with any other form of identification where they identification may have a variance from state-to-state or country-to-country (e.g., passports). The information card is particularly useful for homeland security. Such improvements, changes and modifications within the skill of the art are intended to be covered by the appended claims.

Having described the invention, the following is claimed:

1. An information card comprising:
memory device for storing validity information of driver's licenses from more than one jurisdiction;
means for selectively accessing validity information for a selected jurisdiction; and
means for displaying the selected accessed validity information.

2. The information card of claim 1 wherein said memory device is a removable memory chip.

3. The information card of claim 1 wherein said memory device is a programmable read/write memory.

4. The information card of claim 3 wherein said memory device is accessible through a USB connector.

5. The information card of claim 1 further including a clipboard, said clipboard having a holding device for holding said information card.

6. An information card usable to verify information on a plurality of identification cards from associated different jurisdictions, said information card comprising:
memory device for storing validity information for the identification cards for each of the possible jurisdictions;
means for selectively accessing validity information for a selected jurisdiction; and
display for displaying the selected accessed validity information for the selected jurisdiction.

7. The information card of claim 6 wherein said memory device is a removable memory chip.

8. The information card of claim 6 wherein said memory device is a programmable read/write memory.

9. The information card of claim 8 wherein said memory device is accessible through a USB connector.

10. The information card of claim 6 further including a clipboard, said clipboard having a holding device for holding said information card.

11. A method for verifying information on a plurality of identification cards from associated different jurisdictions, said method comprising the steps of:
storing validity information for each of the possible jurisdictions;
selectively accessing the stored validity information; and
displaying the selected accessed validity information for the selected jurisdiction.
